(19) United States
(12) Patent Application Publication
(10) Pub. No.: US 2018/0230839 A1
(43) Pub. Date: Aug. 16, 2018

(54) TURBINE ENGINE SHROUD ASSEMBLY

(71) Applicant: General Electric Company, Schenectady, NY (US)

(72) Inventors: Kirk D. Gallier, Cincinnati, OH (US); Edward Charles Vickers, Cincinnati, OH (US)

(21) Appl. No.: 15/432,269

(22) Filed: Feb. 14, 2017

(51) Int. Cl. F01D 11/02; F02K 3/06

(52) U.S. Cl. CPC F01D 11/02; F05D 2240/56; F05D 2220/323; F02K 3/06

(57) ABSTRACT

A shroud assembly for a turbine engine comprises a plurality of circumferentially arranged shroud segments, each terminating in circumferentially spaced first and second shiplap elements, where the first shiplap element of one shroud segment can overlap the second shiplap element of an adjacent shroud segment.

### BACKGROUND OF THE INVENTION

Turbine engines, and particularly gas or combustion turbine engines, are rotary engines that extract energy from a flow of pressurized combusted gases passing through the engine onto a multitude of rotating turbine blades. The rotating turbine blades can be supported by shrouds that are interlocked to form a circumferential casing to the turbine.

### BRIEF DESCRIPTION OF THE INVENTION

In one aspect, a shroud assembly for a rotating blade assembly of a turbine engine comprises a plurality of circumferentially arranged shroud segments, where the shroud segments circumferentially terminate in circumferentially spaced first and second shiplap elements, and the first shiplap element of one shroud segment overlaps the second shiplap element of an adjacent shroud segment.

In another aspect, a shroud segment comprises a body having first and second circumferential edges, a first shiplap element located at the first circumferential edge, and a second shiplap element located at the second circumferential edge and located radially inward of the first shiplap element.

In yet another aspect, a method of fluidly sealing shroud segments of a shroud assembly comprises circumferentially overlapping edges of the shroud segments.

### BRIEF DESCRIPTION OF THE DRAWINGS

In the drawings:

FIG. 1 is a schematic cross-sectional diagram of a turbine engine for an aircraft.

FIG. 2 is a circumferential view of a portion of a turbine assembly in the turbine engine of FIG. 1.

FIG. 3 is an axial view of a shroud segment in the turbine assembly of FIG. 2.

FIG. 4 illustrates two overlapping shroud segments from FIG. 3 with a seal.

FIG. 5 illustrates two overlapping shroud segments from FIG. 3 with a brush seal.

FIG. 6 illustrates two overlapping shroud segments from FIG. 3 with both brush and ring seals.

FIG. 7 illustrates two overlapping shroud segments from FIG. 3 with a spline seal and a discourager.

FIG. 8 illustrates two overlapping shroud segments from FIG. 3 sealed by direct contact with one another.

### DESCRIPTION OF EMBODIMENTS OF THE INVENTION

The described embodiments of the present invention are directed to a shroud assembly for an airfoil. For purposes of illustration, the present invention will be described with respect to the turbine for an aircraft turbine engine. It will be understood, however, that the invention is not so limited and may have general applicability within an engine, including compressors, as well as in non-aircraft applications, such as other mobile applications and non-mobile industrial, commercial, and residential applications.

As used herein, the term “forward” or “upstream” refers to moving in a direction toward the engine inlet, or a component being relatively closer to the engine inlet as compared to another component. The term “aft” or “downstream” used in conjunction with “forward” or “upstream” refers to a direction toward the rear or outlet of the engine or being relatively closer to the engine outlet as compared to another component.

Additionally, as used herein, the terms “radial” or “radially” refer to a dimension extending between a center longitudinal axis of the engine and an outer engine circumference.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present invention, and do not create limitations, particularly as to the position, orientation, or use of the invention. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

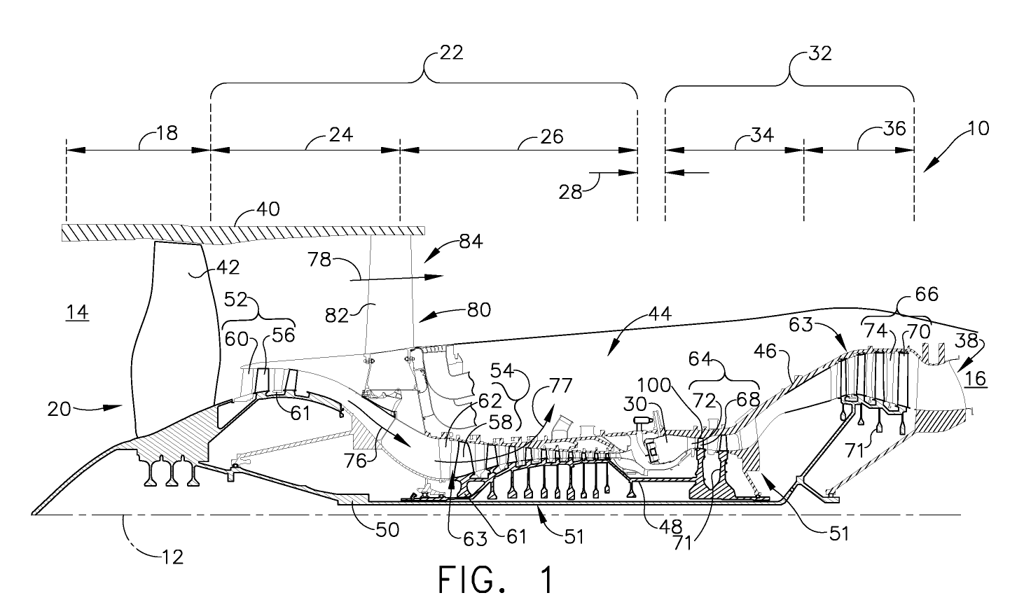

FIG. 1 is a schematic cross-sectional diagram of a gas turbine engine 10 for an aircraft. The engine 10 has a generally longitudinally extending axis or centerline 12 extending forward 14 to aft 16. The engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including a HP turbine 34, and a LP turbine 36, and an exhaust section 38.

The fan section 18 includes a fan casing 40 surrounding the fan 20. The fan 20 includes a plurality of fan blades 42 disposed radially about the centerline 12. The HP compressor 26, the combustor 30, and the HP turbine 34 form a core 44 of the engine 10, which generates combustion gases. The core 44 is surrounded by core casing 46, which can be coupled with the fan casing 40.

A HP shaft or spool 48 disposed coaxially about the centerline 12 of the engine 10 drivingly connects the HP turbine 34 to the HP compressor 26. A LP shaft or spool 50, which is disposed coaxially about the centerline 12 of the engine 10 within the larger diameter annular HP spool 48, drivingly connects the LP turbine 36 to the LP compressor 24 and fan 20. The spools 48, 50 are rotatable about the engine centerline and couple to a plurality of rotatable elements, which can collectively define a rotor 51.

The LP compressor 24 and the HP compressor 26 respectively include a plurality of compressor stages 52, 54, in which a set of compressor blades 56, 58 rotate relative to a corresponding set of static compressor vanes 60, 62 to compress or pressurize the stream of fluid passing through the stage. In a single compressor stage 52, 54, multiple compressor blades 56, 58 can be provided in a ring and can extend radially outwardly relative to the centerline 12, from a blade platform to a blade tip, while the corresponding static compressor vanes 60, 62 are positioned upstream of and adjacent to the rotating blades 56, 58. It is noted that the number of blades, vanes, and compressor stages shown in FIG. 1 were selected for illustrative purposes only, and that other numbers are possible.

The blades 56, 58 for a stage of the compressor can be mounted to (or integral to) a disk 61, which is mounted to the corresponding one of the HP and LP spools 48, 50. The vanes 60, 62 for a stage of the compressor can be mounted to the core casing 46 in a circumferential arrangement.

The HP turbine 34 and the LP turbine 36 respectively include a plurality of turbine stages 64, 66, in which a set of turbine blades 68, 70 are rotated relative to a corresponding set of static turbine vanes 72, 74 (also called a nozzle) to extract energy from the stream of fluid passing through the stage. In a single turbine stage 64, 66, multiple turbine blades 68, 70 can be provided in a ring and can extend radially outwardly relative to the centerline 12 while the corresponding static turbine vanes 72, 74 are positioned upstream of and adjacent to the rotating blades 68, 70. It is noted that the number of blades, vanes, and turbine stages shown in FIG. 1 were selected for illustrative purposes only, and that other numbers are possible.

The blades 68, 70 for a stage of the turbine can be mounted to a disk 71, which is mounted to the corresponding one of the HP and LP spools 48, 50. The vanes 72, 74 for a stage of the compressor can be mounted to the core casing 46 in a circumferential arrangement.

Complementary to the rotor portion, the stationary portions of the engine 10, such as the static vanes 60, 62, 72, 74 among the compressor and turbine section 22, 32 are also referred to individually or collectively as a stator 63. As such, the stator 63 can refer to the combination of non-rotating elements throughout the engine 10.

In operation, the airflow exiting the fan section 18 is split such that a portion of the airflow is channeled into the LP compressor 24, which then supplies pressurized air 76 to the HP compressor 26, which further pressurizes the air. The pressurized air 76 from the HP compressor 26 is mixed with fuel in the combustor 30 and ignited, thereby generating combustion gases. Some work is extracted from these gases by the HP turbine 34, which drives the HP compressor 26. The combustion gases are discharged into the LP turbine 36, which extracts additional work to drive the LP compressor 24, and the exhaust gas is ultimately discharged from the engine 10 via the exhaust section 38. The driving of the LP turbine 36 drives the LP spool 50 to rotate the fan 20 and the LP compressor 24.

A portion of the pressurized airflow 76 can be drawn from the compressor section 22 as bleed air 77. The bleed air 77 can be drawn from the pressurized airflow 76 and provided to engine components requiring cooling. The temperature of pressurized airflow 76 entering the combustor 30 is significantly increased. As such, cooling provided by the bleed air 77 is necessary for operating of such engine components in the heightened temperature environments.

A remaining portion of the airflow 78 bypasses the LP compressor 24 and engine core 44 and exits the engine assembly 10 through a stationary vane row, and more particularly an outlet guide vane assembly 80, comprising a plurality of airfoil guide vanes 82, at the fan exhaust side 84. More specifically, a circumferential row of radially extending airfoil guide vanes 82 are utilized adjacent the fan section 18 to exert some directional control of the airflow 78.

Some of the air supplied by the fan 20 can bypass the engine core 44 and be used for cooling of portions, especially hot portions, of the engine 10, and/or used to cool or power other aspects of the aircraft. In the context of a turbine engine, the hot portions of the engine are normally downstream of the combustor 30, especially the turbine section 32, with the HP turbine 34 being the hottest portion as it is directly downstream of the combustion section 28. Other sources of cooling fluid can be, but are not limited to, fluid discharged from the LP compressor 24 or the HP compressor 26.

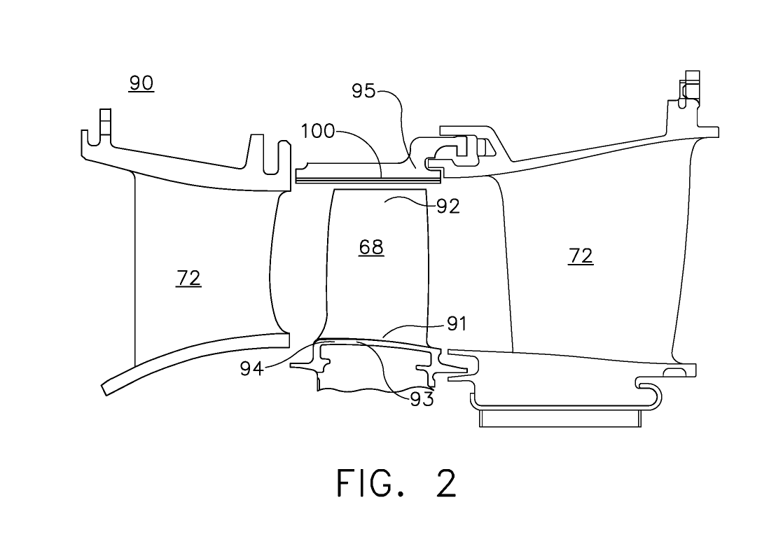

FIG. 2 shows a circumferential view of a portion of a turbine assembly 90 from the turbine engine in FIG. 1. The turbine assembly 90 comprises the turbine blade 68 extending from a root 91 to a tip 92, where the root 91 is proximate a platform 93 that forms an inner band 94 that rotates with the blade 68. The tip 92 is adjacent a shroud 100 that forms an outer band 95 surrounding the rotating blade 68.

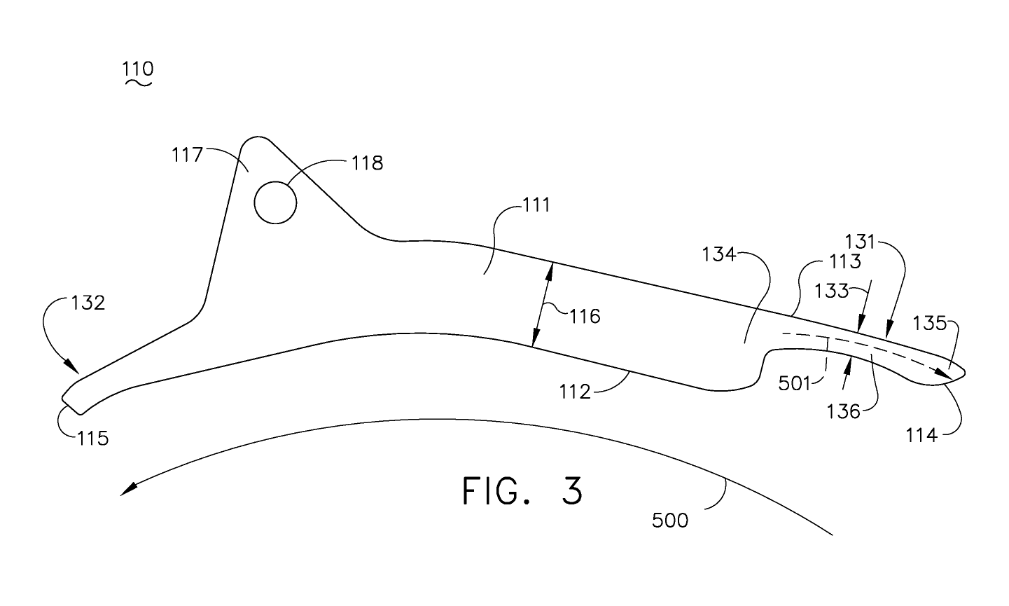

FIG. 3 illustrates an axial view of a shroud segment 110 in the shroud 100 of FIG. 2. Each of the shroud segments 110 can comprise a body 111 having a radially inner surface 112, radially outer surface 113, first circumferential edge 114, a second circumferential edge 115, a first shiplap element 131 located at the first circumferential edge 114, and a second shiplap element 132 located at the second circumferential edge 115 and also positioned radially inward of the first shiplap element 131. Each of the shiplap elements 131, 132 can extend in a circumferential direction away from the body 111; additionally, at least one of the shiplap elements 131, 132 can have a profile comprising a first radial portion 134, a second radial portion 135, and a circumferential portion 136 that connects the first and second radial portions 134, 135. Further, the width 116 of the body 111 can be greater than the width 133 of each of the shiplap elements 131, 132, and the body 111 may also comprise a pin mount 117 extending radially away from the body 111 and including a pin hole 118. Other mounting methods suitable for the shroud environment are also contemplated for mounting the shroud segments 110.

The shroud segments 110, when combined into the shroud 100, can surround the rotating blade assembly 68. Air can move in a local streamline 500 (indicated by the arrow 500) which can be due to the blade assembly 68 rotating in the same direction as the arrow 500; however, the disclosure is not so limited and the local streamline 500 may also exist near a shroud 100 that surrounds a non-rotating component in the turbine engine 10. In addition, a line 501 traversing the first radial portion 134 to the second radial portion 135 along the circumferential portion 136 can be in a direction opposite that of the local streamline 500.

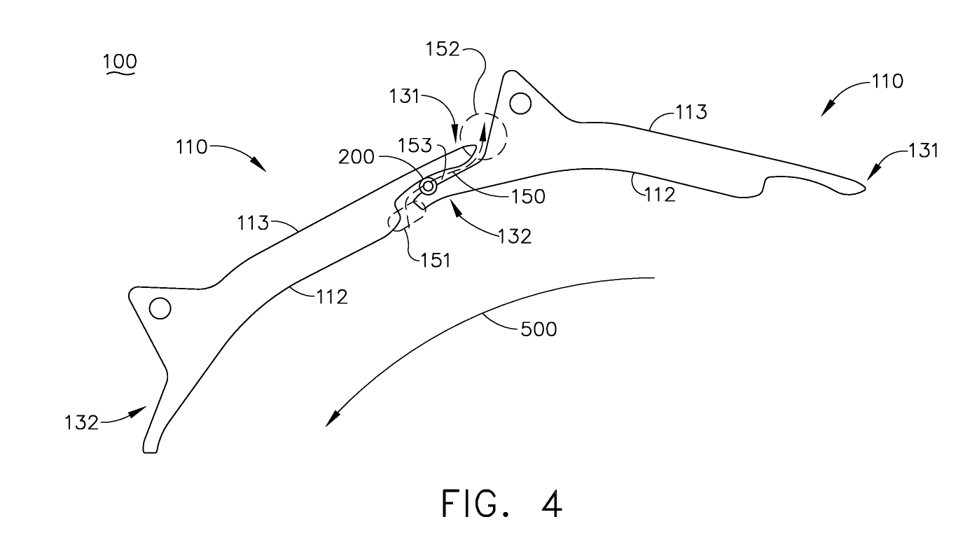

In FIG. 4, two adjacent shroud segments 110 from FIG. 3 are illustrated where the first shiplap element 131 of one shroud segment 110 can overlap the second shiplap element 132 of an adjacent shroud segment 110 as shown. The overlapping shiplap elements 131, 132 can define a labyrinth flow path 150 having a first opening 151 on the inner surface 112 of each shroud segment 110 and a second opening 152 on the outer surface 113 of each shroud segment 110. The gap between the shiplap elements 131, 132 can define a passage 153 connecting the first and second openings 151, 152 as shown; the direction of the passage 153 from the first opening 151 toward the second opening 152 is opposite the direction 500 of the local streamline. Further, a seal, such as a rope or wire seal 200, may be positioned within the passage 153 of the labyrinth flow path 150. Any of the seals disclosed herein can be made of any material suitable for the shroud environment within the engine, such as metal, coated metal, ceramic, ceramic matrix composite (CMC), or a metal/ceramic composite, and the material used may be conformable.

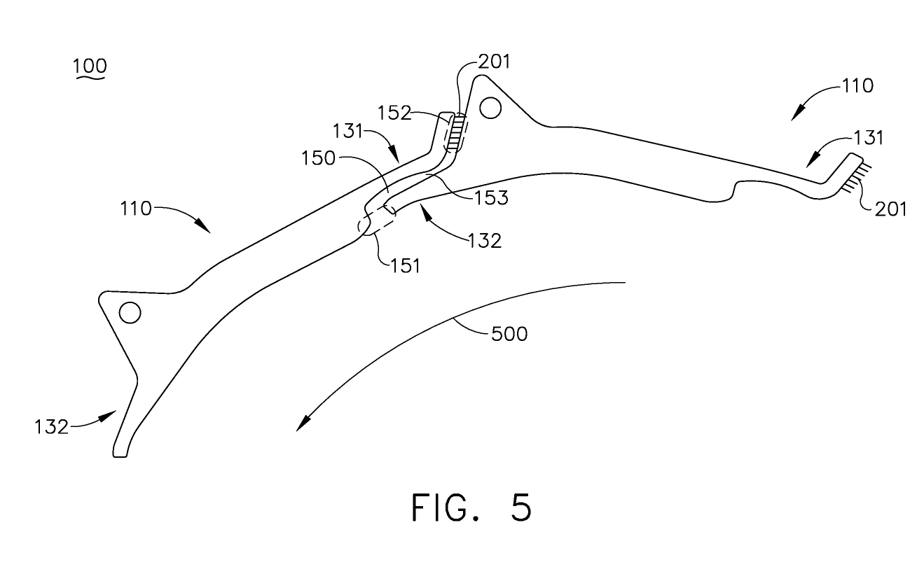

FIG. 5 illustrates one alternative option for sealing the gap between the shiplap elements 131, 132 of adjacent shroud segments 110 similar to that shown in FIG. 4. An axial running brush seal 201 is provided with the first shiplap element 131 and can be positioned within the second opening 152 of the labyrinth flow path 150.

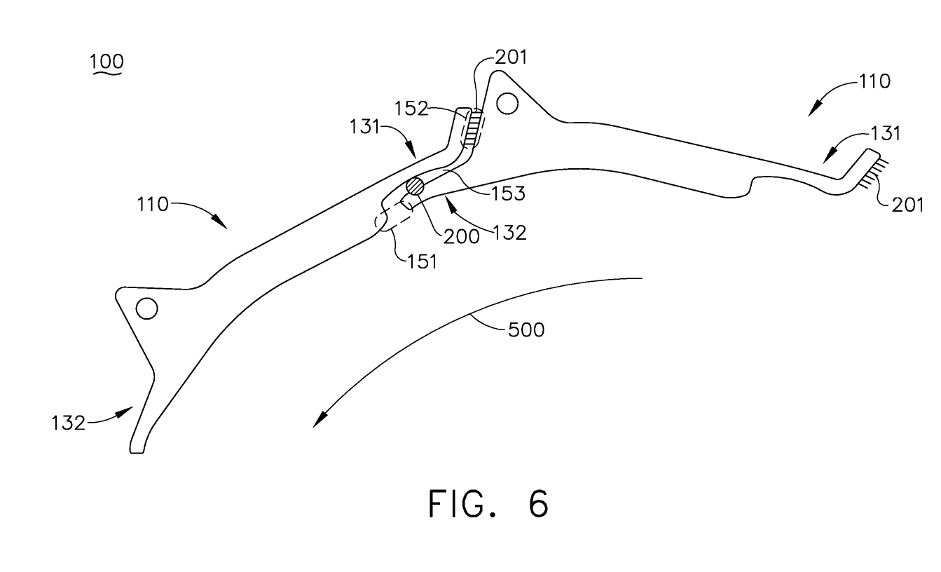

FIG. 6 illustrates another alternative option for sealing the gap between the shiplap elements 131, 132. It is contemplated that multiple seals may be used in combination; for example, the axial running brush seal 201 can be positioned within the second opening 152 while the rope or wire seal 200 is positioned within the passage 153. The non-limiting example shown is intended to illustrate the sealing concept, and other combinations of seals, and the positioning thereof, are also contemplated.

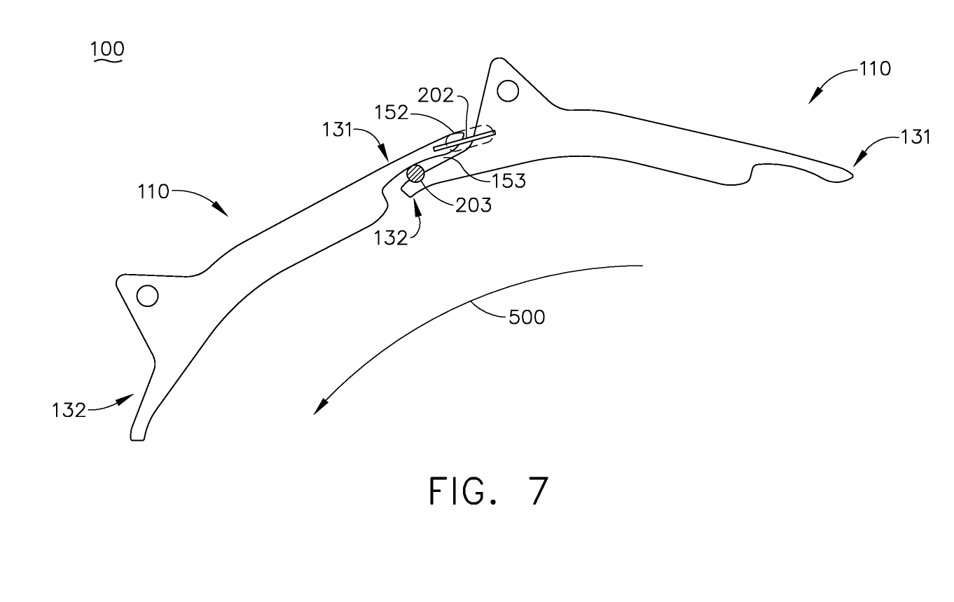

In FIG. 7, yet another alternative option for sealing the gap between the shiplap elements 131, 132 includes positioning the axial spline seal 202 within the second opening 152 while a discourager 203 is positioned within the passage 153 of the labyrinth flow path 150. The discourager 203 is intended to not function as a seal, but only to discourage or retard the flow of gases from entering the flow path 150; it is contemplated that the discourager 203 may be made of rope or wire, but such material examples are not intended to be limiting.

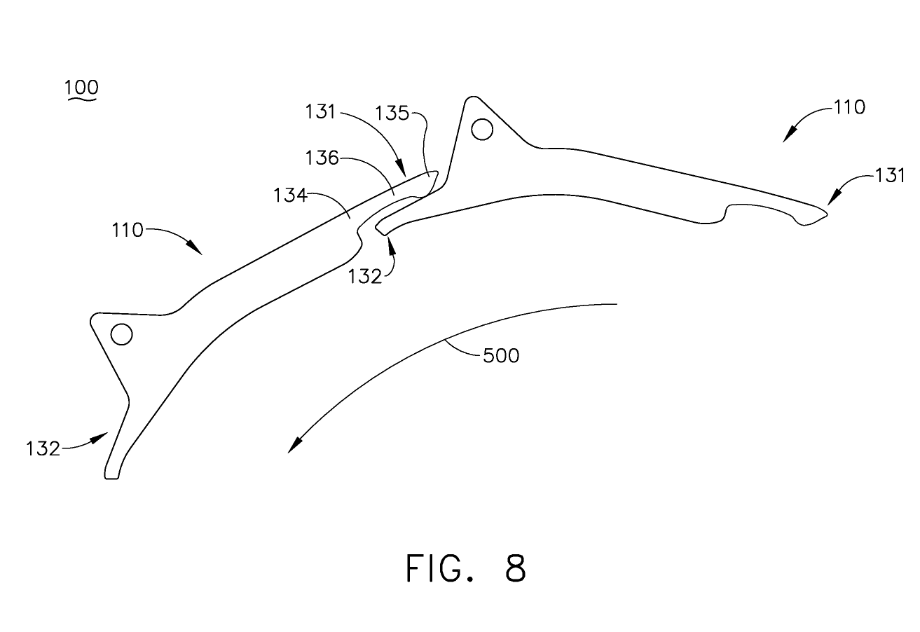

In FIG. 8, adjacent shroud segments 110 are illustrated as sealing the shiplap by the direct contact of the second radial portion 135 of the first shiplap element 131 of one shroud segment 110 with the second shiplap element 132 of the adjacent shroud segment 110. It can be appreciated that the use of direct contact between shiplap elements may be utilized to seal the shiplap. Direct contact of shiplap elements may also be utilized in combination with seals, discouragers, or combinations thereof, and combinations of sealing elements and discouragers not otherwise illustrated are contemplated for use at various positions within the flow path 150. Further, the seals 200, 201, 202 may be provided with either or both of the first and second shiplap elements 131, 132.

It can be appreciated that circumferentially overlapping shiplap elements 131, 132 of adjacent shroud segments 110 can fluidly seal the segments 110 as illustrated herein. This arrangement can seal the gap between overlapping circumferential edges 114, 115 by placing a seal 200, 201, 202, discourager 203, or any combination thereof in the gap, as shown in FIGS. 4-8. It is appreciated that hot gases flowing near the inner surface 112 can carry a large amount of kinetic and thermal energy in the streamline direction 500; thus the seals 200, 201, 202 and/or discourager 203 can be protected from degradation by positioning within the passage 153 out of the direct gas path. Further, the construction of the passage in the opposite direction of the local streamline 500 (FIG. 4) can cause a reduction in the amount of hot gases flowing through the passage 153. By the sealing method described herein, hot gases can therefore be prevented from entering the region adjacent the outer surface 113 of the shroud segments 110 where temperature-sensitive components may be positioned. It is further appreciated that the improved sealing method can allow the engine to perform at higher temperatures, which can improve its operating efficiency.

It should be understood that application of the disclosed design is not limited to turbine engines with fan and booster sections, but is applicable to turbojets and turboshaft engines as well.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A shroud assembly for a rotating blade assembly of a turbine engine comprising:
a plurality of circumferentially arranged shroud segments;
the shroud segments circumferentially terminating in circumferentially spaced first and second shiplap elements; and
the first shiplap element of one shroud segment overlapping the second shiplap element of an adjacent shroud segment.

2. The shroud assembly of claim 1 wherein the overlapping first and second shiplap elements define a labyrinth flow path having a first opening on a radially inner surface of the shroud segments and a second opening on a radially outer surface of the shroud segments, and a passage connecting the first and second openings.

3. The shroud assembly of claim 2 wherein the direction of the passage from the first to the second opening is opposite a direction of rotation of the rotating blade assembly.

4. The shroud assembly of claim 2 further comprising at least one of a seal, discourager, or conformable material within the labyrinth flow path.

5. The shroud assembly of claim 4 further comprising a seal and a discourager located within the labyrinth flow path.

6. The shroud assembly of claim 4 wherein the seal comprises at least one of a spline seal or brush seal.

7. The shroud assembly of claim 4 wherein the seal is located in at least one of the passage or second opening.

8. The shroud assembly of claim 4 wherein the discourager comprises at least one of a rope or wire located within the labyrinth flow path.

9. The shroud assembly of claim 1 wherein the shroud segment comprises a body and the first and second shiplap elements extend from the body.

10. The shroud assembly of claim 9 wherein the first and second shiplap elements are thinner than the body.

11. The shroud assembly of claim 10 wherein the first shiplap element is located radially outward of the second shiplap element.

12. The shroud assembly of claim 9 further comprising a pin mount extending from the body.

13. A shroud segment comprising:
a body having first and second circumferential edges;
a first shiplap element located at the first circumferential edge;
a second shiplap element located at the second circumferential edge and located radially inward of the first shiplap element.

14. The shroud segment of claim 13 comprising at least one of a seal, discourager or conformable material provided with one of the first and second shiplap elements.

15. The shroud segment of claim 13 wherein at least one of the first and second shiplap elements have a profile comprising first and second radial portions connected by a circumferential portion.

16. The shroud segment of claim 15 wherein a line traversing the first radial portion to the second radial portion along the circumferential portion is in a direction opposite the direction of a local streamline adjacent the shroud segment.

17. A method of fluidly sealing shroud segments of a shroud assembly by circumferentially overlapping edges of the shroud segments.

18. The method of claim 17 further comprising at least retarding fluid flow between the overlapping edges.

19. The method of claim 18 further comprising sealing a gap between the overlapping edges to retard the fluid flow.

20. The method of claim 19 wherein the sealing comprises placing a seal or discourager within the gap.
